(19) United States
(12) Patent Application Publication
(10) Pub. No.: US 2010/0189235 A1
(43) Pub. Date: Jul. 29, 2010

(54) Remote Ausculation System Using Wired-wireless Network

(76) Inventor: Jae-Hak Um, Seongnam-si (KR)

Correspondence Address: ROBERT W. J. USHER;PATENT AGENT, 1133 BROADWAY, #1515, NEW YORK, NY, 10010, US

(21) Appl. No.: 12/440,194

(22) PCT Filed: Feb. 5, 2008
(86) PCT No.: PCT/KR08/00699

§ 371 Date: Mar. 5, 2009

(30) Foreign Application Priority Data
Feb. 5, 2007 (KR) 10-2007-0011591

(51) Int. Cl. H04M 11/00

(52) U.S. Cl. 379/106.02

(57) ABSTRACT

The present invention relates to a remote auscultation system using wired/wireless communication network, in which an electronic stethoscope is connected to a communication device like a wired telephone or a mobile phone or a computer by interposing a separated communication module between them, and then the auscultation sounds of the patients obtained through the stethoscope are transmitted to a telephone of a medical doctor using wired/wireless communication network, and so the medical doctor can give remote medical treatment to a patient using wired/wireless communication network, and further, which can be connected and used directly to existing communication devices, and the remote auscultation system using wired/wireless communication network comprises; an electronic stethoscope (10) outputting auscultation sound signals obtained from a patient; a communication module (20) amplifying the auscultation sound signals being outputted from the electronic stethoscope (10) in predetermined volume and then outputting selectively the amplified stethoscope sound signals or the sound signals through a receiver (31); a patient's telephone (30) transmitting the sound signals from a receiver (31) or the auscultation sound signals selected in the communication module (20) to a telephone of medical doctor (40) through a communication network; a telephone of medical doctor (40) outputting the auscultation sound signals transmitted through the patient's telephone (30) or the sound signals through the receiver (31) to a receiver (41) or to a headset (42).

### TECHNICAL FIELD

The present invention relates to a remote auscultation system using electronic stethoscope, and more particularly, to a remote auscultation system using wired/wireless communication network, in which an electronic stethoscope is connected to a communication device like a wired telephone or a mobile phone or a computer by interposing a separated communication module between them, and then the auscultation sounds of the patients obtained through the stethoscope are transmitted to a telephone of a medical doctor using wired/wireless communication network, and so the medical doctor can give remote medical treatment to a patient using wired/wireless communication network, and further, which can be connected and used directly to existing communication devices.

### BACKGROUND ART

As generally known, an electronic stethoscope converts auscultation sounds obtained from patient into electrical signals and then outputs them through output units like speakers or earphones.

These electronic stethoscopes offer more useful advantages than conventional mechanical ones do.

In addition, remote medical treatment technique using electronic stethoscopes, which enables a medical doctor to stethoscope a patient in remote place through communication networks like internet or telephone, are recently introduced.

However, most of conventional remote medical treatment techniques need newly produced communication devices having such technique within in order to realize such remote medical treatment techniques and so it cause much costs. Furthermore, they cannot be applied directly to currently used communications equipments and so cannot be used commonly.

### DISCLOSURE OF INVENTION

### Technical Problem

To overcome the above described problems, the purpose of the present invention is to provide a remote auscultation system using wired/wireless communication network, in which an electronic stethoscope is connected to a communication device like a wired telephone or a mobile phone or a computer by interposing a separated communication module between them, and then the auscultation sounds of the patients obtained through the stethoscope are transmitted to a telephone of a medical doctor using wired/wireless communication network, and so the medical doctor can give remote medical treatment to a patient using wired/wireless communication network, and further, which can be applied directly to existing communication devices.

### Technical Solution

To accomplish the above objective of the present invention and other advantages and in accordance with the purpose of the present invention, there is provided a remote auscultation system comprising an electronic stethoscope outputting auscultation sound signals obtained from a patient; a communication module amplifying the auscultation sound signals being outputted from the electronic stethoscope in predetermined volume and then outputting selectively the amplified auscultation sound signals or the sounds signals through a receiver; a patient's telephone transmitting the sound signals from a receiver or the auscultation sound signals selected in the communication module to the telephone of medical doctor through a communication network; a telephone of medical doctor outputting the auscultation sound signals transmitted through the patient's telephone or the sound signals through a receiver to a receiver or a headset.

To accomplish the above objective of the present invention, there is provided furthermore a remote auscultation system comprising an electronic stethoscope outputting auscultation sound signals obtained from a patient; a communication module amplifying the auscultation sound signals being outputted from the electronic stethoscope in predetermined volume and then outputting selectively the amplified stethoscope sound signals or voice signals through a receiver; a patient's computer transmitting the sound signals from a receiver or the auscultation sound signals selected in the communication module to a computer of medical doctor through an Internet; a computer of medical doctor outputting the auscultation sound signals transmitted through the patient's computer or the sound signals through the receiver to a headset.

### Advantageous Effects

As described above, the present invention can cut down cost remarkably, because it provides a remote auscultation system using wired/wireless communication network, in which an electronic stethoscope is connected to a communication device like a wired telephone or a mobile phone or a computer by interposing a separated communication module between them, and then the auscultation sounds of the patients obtained through the stethoscope are transmitted to a telephone of a medical doctor using wired/wireless communication network, and so the medical doctor can give remote medical treatment to a patient using wired/wireless communication network, and further, which can be connected and used directly to existing communication devices.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a constitution view of a remote auscultation system using wired/wireless communication network according to a preferred embodiment of the present invention;

FIG. 2 is a circuit block view of a electronic stethoscope according to a preferred embodiment of the present invention;

FIG. 3 is a constitution view of a remote auscultation system using wired/wireless communication network according to another preferred embodiment of the present invention;

### BEST MODE FOR CARRYING OUT THE INVENTION

Reference will now be made in detail to preferred embodiments of the present invention, example of which is illustrated in the accompanying drawings.

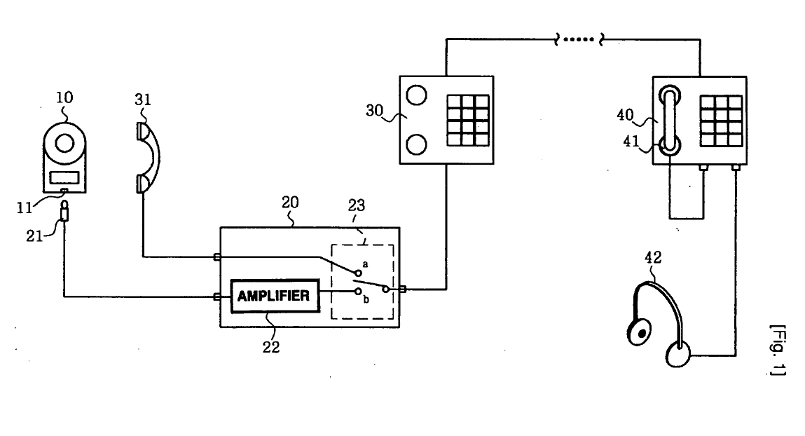

FIG. 1 is a constitution view of a remote auscultation system using wired/wireless communication network according to a preferred embodiment of the present invention.

As illustrated, a remote auscultation system using wired/wireless communication network according to a preferred embodiment of the present invention comprises

a electronic stethoscope (10) outputting auscultation sound signals obtained from a patient; a communication module (20) amplifying the auscultation sound signals being outputted from the electronic stethoscope (10) in predetermined volume and then outputting selectively the amplified auscultation sound signals or the sounds signals through a receiver (31); a patient's telephone (30) transmitting the sound signals from the receiver (31) or the auscultation sound signals selected in the communication module (20) to the telephone of medical doctor (40) through a communication network; a telephone of medical doctor (40) outputting the auscultation sound signals transmitted through the patient's telephone (30) or the sound signals through the receiver (31) to a receiver (41) or a headset (42).

According to the present invention, the patient's telephone (30) as well as the telephone of medical doctor (40) can be applied not only to a general wired telephone, but also to a wired/wireless video phone and to a cellular phone as well.

Hereinafter, a constitution of the present invention will be described more in detail.

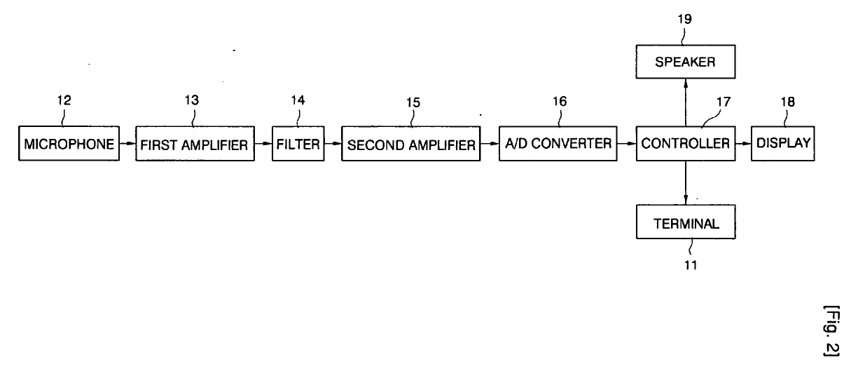

As shown in FIG. 2, the electronic stethoscope (10) includes a microphone (12), a first amplifier (13), a filter (14), a second amplifier (15), A/D converter (16), a controller (17), an display (18), a speaker (19) and an output terminal (11).

The microphone (12) converts auscultation oscillation sounds collected from auscultation region of a patient's body into electric signals, and the first amplifier (13) firstly amplifies weak analog auscultation sound signals being inputted from the microphone (12).

The filter (14) filters analog oscillation sound signals being inputted through the first amplifier (13) in predetermined frequency band and outputs them, and the second amplifier (15) amplifies the oscillation sound signals being outputted through the filter (14) secondly, and the A/D converter (16) converts the analog auscultation sound signals being outputted through the second amplifier (15) into the digital sings.

The digital auscultation sound signals being outputted from the A/D converter (16) are inputted and stored to the controller (17) and are outputted to the display (18) and/or the speaker (19) by the controller (17).

Further, the controller (17) outputs the inputted auscultation sound signals to the output terminal (11) and then transmits them to the outer devices.

The communication module (20) includes an amplifier (22) amplifying the stethoscope sound output signals being outputted to the output terminal (11) of the electronic stethoscope (10) fixedly insomuch as the level of the general telephone conversation sound, and a switching unit (23) connecting the sound output through the receiver (31) or the output of the amplifier (22) selectively to the patient's telephone (30).

Accordingly, in the communication module (20), the input jack (21) is connected to the output terminal (11) of the electronic stethoscope (10), and the receiver (31) of the patient's telephone (30) is connected to the other input terminal, and the output terminal of the switching unit (23) is connected to the main body of the patient's telephone (30). At this moment, if a switch moving-piece of the switching unit (23) of the communication module (20) is turned to the switch contact point (a), then the receiver (31) is connected to the telephone (30) of the patient and the sound communication becomes possible, and if a switch moving-piece of the switching unit (23) of the communication module (20) is turned to the switch contact point (b), then the output of the stethoscope (10) is connected to the patient's telephone (30) and then the auscultation sound signals of the stethoscope (10) are transmitted through the patient's telephone.

Furthermore, according to the present invention, the switch can be so built that the communication conversation sound of the receiver (31) of the communication module (20) and the auscultation sound signals can be transmitted at the same time through the patient's telephone (30).

Accordingly, in this case, both the conversation sounds of the receiver (31) and the auscultation sound signals of the stethoscope (10) can be transmitted at the same time or not transmitted at the same time.

The structure of the above switch is the same as the structure of general switch and so the explanation of it will be here omitted.

Hereinafter, the whole operation of the remote auscultation system using wired/wireless communication network according a preferred embodiment of the present invention will be described.

Firstly, the patient asking for remote auscultation treatment inserts and connects the input jack (21) of the communication module (20) into the output terminal (11) of the electronic stethoscope (10).

And he connects the receiver (31) to the other input terminal of the communication module (20) and connects the output terminal of the communication module (20) to the main body of the patient's telephone (30).

Then, the patient makes the receiver (31) communicable by turning the switching unit (23) of the communication module (20) to the connecting point (a) and calls to the telephone of medical doctor (40).

When the patient communicates with the medical doctor, and the doctor instructs the patient to send the auscultation sound data, the patient turns the switching unit (23) of the communication module (20) to the contacting point (b) and auscultates the appointed region of the patient's body using the electronic stethoscope (10).

At this time, the auscultation oscillation sounds auscultated on the auscultation region of the patient's body through the electronic stethoscope (10) are converted through the microphone (12) into the electric signals, and the weak analog auscultation sound signals are amplified firstly passing by first amplifier (13).

The amplified signals are filtered through the filter (14) to the predetermined frequency band and are amplified secondly through the second amplifier (15), and the analog auscultatione sound signals being amplified and outputted through the second amplifier (15) are converted into digital signals passing by the A/D converter (16).

The digital auscultation sound signals being outputted from the A/D converter (16) are stored in the controller (17) and outputted to the display (18) and the speaker (19) and at the same time outputted to the output terminal (11).

The auscultation sound data outputted to the output terminal (11) are amplified through the amplifier (22) of the stethoscope telephone module (20) in the same level as the general telephone conversation voice and this auscultation sound data are inputted into the main body of the patient's telephone (30) passing by the switching unit (23) and transmitted to the main body of the telephone (40) of medical doctor through wired communication network.

Therefore, the medical doctor can pass judgment on the state of the patient by reading the auscultation sounds of the patient obtained from the receiver (41).

Further if needed, he can hear more accurate auscultation sounds by connecting the separate headset (42) to his telephone (40).

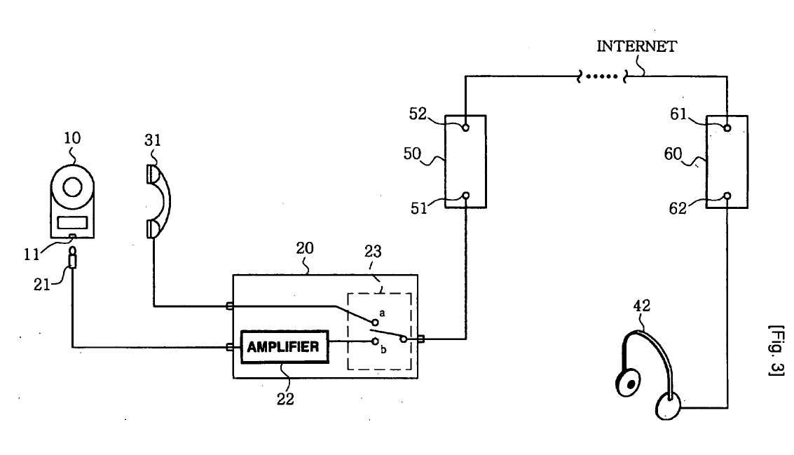

FIG. 3 illustrates another preferred embodiment.

As illustrated, the remote auscultation system using wired/wireless communication network according to another preferred embodiment of the present invention comprises;

an electronic stethoscope (10) outputting auscultation sound signals obtained from a patient; a communication module (20) amplifying the auscultation sound signals being outputted from the electronic stethoscope (10) in predetermined volume and then outputting selectively the amplified stethoscope sound signals or sound signals through a receiver (31); a patient's computer (50) transmitting the sound signals from a receiver (31) or the auscultation sound signals selected in the communication module (20) to a computer of medical doctor (60) through an Internet; a computer of medical doctor (60) outputting the auscultation sound signals transmitted through the patient's computer (50) or the sound signals through the receiver (31) to a headset (42).

According to the present invention, the receiver (31) of the patient's computer (50) can be composed of a microphone transmitting sound.

In addition, there is provided the communication module (20) in which an input jack (21) is connected to an output terminal (11) of the electronic stethoscope (10) and the receiver (31) of the patient's computer (50) is connected to the other input terminal, and the output terminal of the switching unit (23) is connected to a sound input terminal (51) of the patient's computer (50). At this time, if the switch movable piece of the switching unit (23) of the communication module (20) is turned to the switch contacting point (a), the receiver (31) is connected to the patient's computer (50) and so the sound can be transmitted. On the other hand, if the switch movable piece of the switching unit (23) of the communication module (20) is turned to the switch contacting point (b), the output of the stethoscope (10) is connected to the patient's computer (50) and so the auscultation sound signals of the stethoscope (10) are transmitted through the network output terminal (52) of the patient's computer (50).

Furthermore, the auscultation sounds and the sound signals transmitted through the internet are inputted through the network input terminal (61) of the computer of medical doctor (60) and outputted through the headset (42) connected to the sound output terminal (62).

The effect of the present invention as described above is already explained in the preferred embodiment of the present invention and so don t need more repeated explanation. Therefore, according to the present invention, we can see the remote medical treatment through internet possible.

1. In a remote auscultation system using wired/wireless communication network comprising;
an electronic stethoscope (10) outputting auscultation sound signals obtained from a patient;
a patient's telephone (30) transmitting the sound signals obtained by the receiver (31) or the auscultation sound signals obtained by the electronic stethoscope (10) to the telephone of medical doctor (40) through a wired/wireless communication network; and
a telephone of medical doctor (40) outputting the auscultation sound signals transmitted through the patient's telephone (30) or the sound signals through the receiver (31) to a receiver (41) or a headset (42),
a communication module (20), which is further interposed between the electronic stethoscope (10) and the patient's telephone (30), including;
an amplifier (22) amplifying the auscultation sound output signals being outputted to the output terminal (11) of the electronic stethoscope (10) fixedly insomuch as the level of the general telephone conversation sound, and a switching unit (23) connecting the sound output through the receiver (31) of the patient or the output of the amplifier (22) selectively to the patient's telephone (30)

2. The remote auscultation system using wired/wireless communication network according claim 1, wherein the communication module (20) can be so built that the telephone conversation sounds of the patient's receiver (31) and the auscultation sound signals of the stethoscope (10) can be transmitted at the same time through the patient's telephone (30) or at the same time not through the patient's telephone (30).
